(19) United States
(12) Patent Application Publication
(10) Pub. No.: US 2009/0230692 A1
(43) Pub. Date: Sep. 17, 2009

(54) DYNAMIC FLUID ENERGY CONVERSION

(76) Inventor: Fernando Gracia Lopez, Garza Garcia (MX)

Correspondence Address: FISH & RICHARDSON P.C., P.O. BOX 1022, MINNEAPOLIS, MN, 55440-1022, US

(21) Appl. No.: 12/402,765

(22) Filed: Mar. 12, 2009

Related U.S. Application Data
(60) Provisional application No. 61/036,398, filed on Mar. 13, 2008.

(51) Int. Cl. F03D 9/00; F04B 17/02

(52) U.S. Cl. 290/55; 417/334

(57) ABSTRACT

Systems, devices, processes, and techniques for harnessing the dynamic energy of a fluid body may be used to generate electric power. In particular implementations, the dynamic energy of a gaseous fluid body is used to drive a pump that pressurizes a pumping fluid. The pressurized pumping fluid may be used, at least in part, to drive an electrical generator.

### CROSS-REFERENCE TO RELATED APPLICATIONS

This application claims the benefit of U.S. Provisional Application No. 61/036,398, filed Mar. 13, 2008, which is incorporated herein by reference in its entirety.

### TECHNICAL FIELD

The present disclosure relates to harnessing dynamic energy of a moving fluid body and, more particularly, to systems, processes, devices, and techniques for converting the moving fluid body's dynamic energy to another type of energy, such as, for example, electrical power.

### BACKGROUND

As the world continues to become more socially and economically advanced, its need for energy will continue to grow. Additionally, as the world's population continues to increase, its energy needs will grow. Thus, the need for energy will continue to expand.

Many traditional techniques for producing energy (e.g., combusting coal or natural gas) have become increasingly expensive with increased energy demand. Also, these techniques, as well as alternative techniques (e.g., nuclear), have numerous environmental drawbacks. Other traditional techniques (e.g., geo-thermal and hydro-electric) have not been able to keep pace with demand.

### SUMMARY

This disclosure relates to harnessing the dynamic energy of a fluid body. The fluid body's dynamic energy may, for example, be used to produce electric power. In particular implementations, for instance, the motion of a gaseous fluid body may be used to pressurize a pumping fluid to drive an electric generator.

In one general aspect, a system for utilizing movements of a gaseous fluid body for generating electrical power may include a pumping mechanism and an electrical power generation mechanism. The pumping mechanism may, for example, include a flow-driven moveable member having a number of radially extending elements. The moveable member may be adapted to rotate in response to movement of a gaseous fluid body around the elements. The pumping mechanism may also include a pump coupled to the moveable member. The pump may be adapted to pressurize a pumping fluid in response to motion of the moveable member. The electrical power generation mechanism may be adapted to utilize the pressurized pumping fluid to generate electrical power.

Certain implementations may include a housing having an inner chamber from which the pump draws the fluid to be pressurized. The inner chamber may serve as a reservoir for the pumping fluid.

The moveable member may, for example, include a hub to which the radially extending elements are coupled. Additionally, the moveable member may include an alignment system adapted to align the member with fluid body movements.

The pump may, for example, include a container having a moveable piston housed therein. The pump may also include at least one fluid inlet conduit coupled to the container and a one-way valve coupled to the at least one fluid inlet conduit. The pump may additionally include at least one fluid outlet conduit coupled to the container and a one-way valve coupled to the at least one fluid outlet conduit.

Particular implementations may include a power conversion mechanism adapted to convey power from the moveable member to the pump. The power conversion mechanism may, for example, include a gear coupled to the movable member and an arm coupled to the pump, wherein the arm is driven by the gear.

Certain implementations may include a second pumping mechanism. The second pumping mechanism may include a fluid-driven moveable member and a pump. The moveable member may, for example, include a number of radially extending elements, and the moveable member may be adapted to rotate in response to movement of a gaseous fluid body around the elements. The pump may, for example, be coupled to the moveable member and adapted to pressurize a pumping fluid in response to motion of the moveable member.

Particular implementations having at least two pumping mechanisms may include a conduit system for combining the pressurized pumping fluid from the first pumping mechanism and the second pumping mechanism. The combined pumping fluid may be conveyed to the power generation mechanism.

In some implementations, the first pumping mechanism may cease supplying pressurized pumping fluid while the first pumping mechanism continues supplying pressurized pumping fluid. For example, the second pumping mechanism may be replaced while the first pumping mechanism continues supplying pressurized pumping fluid.

Certain implementations may include a conduit system for dispersing the fluid from the power generation mechanism to one or more pumping mechanisms. A bypass conduit may be in communication with two conduit systems, and a bypass valve maybe coupled to the bypass conduit. The bypass valve may be adapted to allow flow of the pressurized pumping fluid from a first conduit system to a second conduit system when a predetermined pressure of the pumping fluid is exceeded.

In another general aspect, a process for utilizing movements of a gaseous fluid body for generating electrical power may include driving a pump using the rotation of a flow-driven moveable member that rotates in response to movement of a gaseous fluid body and pressurizing a pumping fluid with the pump. In particular implementations, the movable member may be aligned with fluid body movements. The process may also include conveying the pressurized pumping fluid to an electrical power generator mechanism and generating power with the electrical power generator mechanism using the pressurized pumping fluid.

Particular implementations may include providing the pumping fluid to a chamber from which the pump draws the fluid to be pressurized. The chamber may, for example, serve as a reservoir for the pumping fluid.

Certain implementations may include driving a second pump using the rotation of a second flow-driven moveable member that rotates in response to movement of a gaseous fluid body and pressurizing the pumping fluid with the second pump. The pressurized pumping fluid may be conveyed to the electrical power generator mechanism and the electrical power generator mechanism may generate electrical power using the pressurized pumping fluid from the first pump and the second pump.

Particular implementations may include combining the pressurized pumping fluid from the first pump and the second pump before it arrives at the electrical power generator mechanism. Additionally, the pumping fluid from the electrical power generator mechanism may be conveyed to the pumps.

In certain implementations, pressurized pumping fluid may cease to be supplied to the electrical power generator mechanism from the second pump while continuing to supply pressurized pumping fluid from the first pump.

The systems, processes, devices, and techniques in this disclosure may have a variety of features. For example, as opposed to generating electrical power through burning fossil fuels (e.g., coal), electrical power may be generated through using a renewable energy source with little, if any, air pollution. Thus, the energy source may be used almost indefinitely and have a small effect on environmental quality. As another example, the energy source may be found at a variety of locations in a variety of countries. Thus, the power generation may be scaled as needed and may have widespread use.

Other features will be apparent from the detailed description, drawings, and claims.

### DESCRIPTION OF DRAWINGS

FIGS. 1-2 are perspective views of an example system for converting dynamic fluid energy.

FIG. 3 is a perspective view of an example energy conversion mechanism for an energy conversion system.

FIGS. 4-5 are cut-away perspective views illustrating an operation of the energy conversion mechanism in FIG. 3.

FIGS. 6-7 are schematic illustrations of a pump at different stages of pumping.

FIGS. 8-9 are perspective views of another example system for converting dynamic fluid energy.

FIG. 10 is a perspective view of a further example system for converting dynamic fluid energy.

FIGS. 11-12 are cross-sectional views of a valve useful for a dynamic fluid energy conversion system.

FIG. 13 is a flow chart illustrating an example process for converting dynamic fluid energy.

FIG. 14 is a flow chart illustrating another example process for converting dynamic fluid energy.

### DETAILED DESCRIPTION

The dynamic energy of a fluid body may be harnessed by various systems, processes, devices, and techniques to produce useful work, such as producing electrical power. In some implementations, for example, systems, processes, devices, and techniques for converting the dynamic energy of a gaseous fluid body into electrical power may include pressurizing a pumping fluid using the flow of the fluid body and using the pressurized pumping fluid to drive a turbine that is coupled to an electrical generator. Other systems, processes, devices, and techniques are possible.

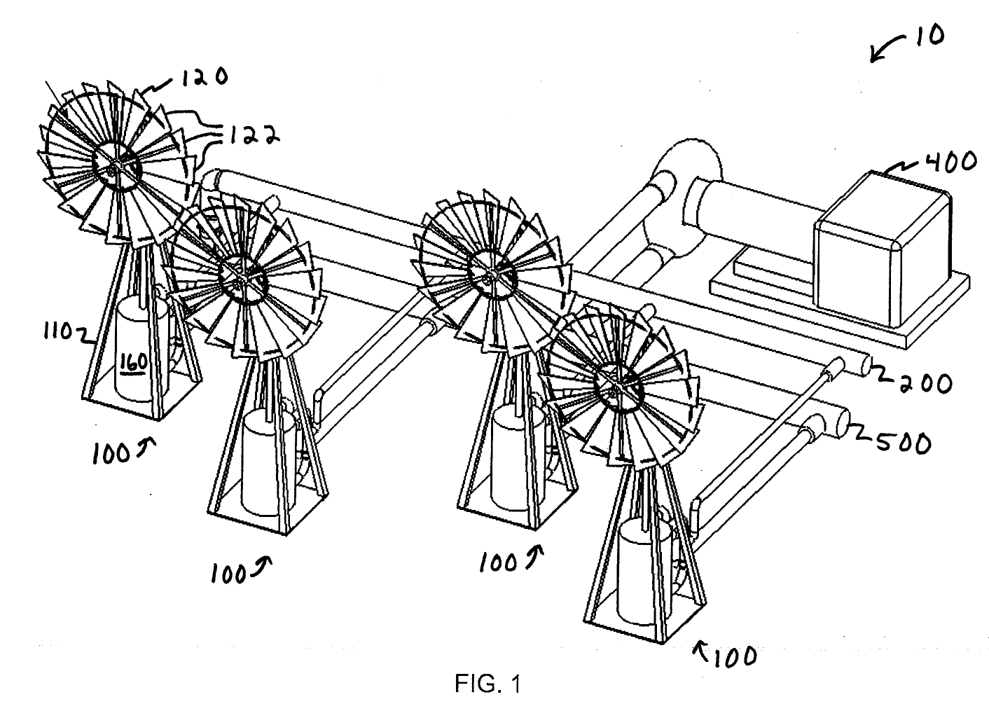

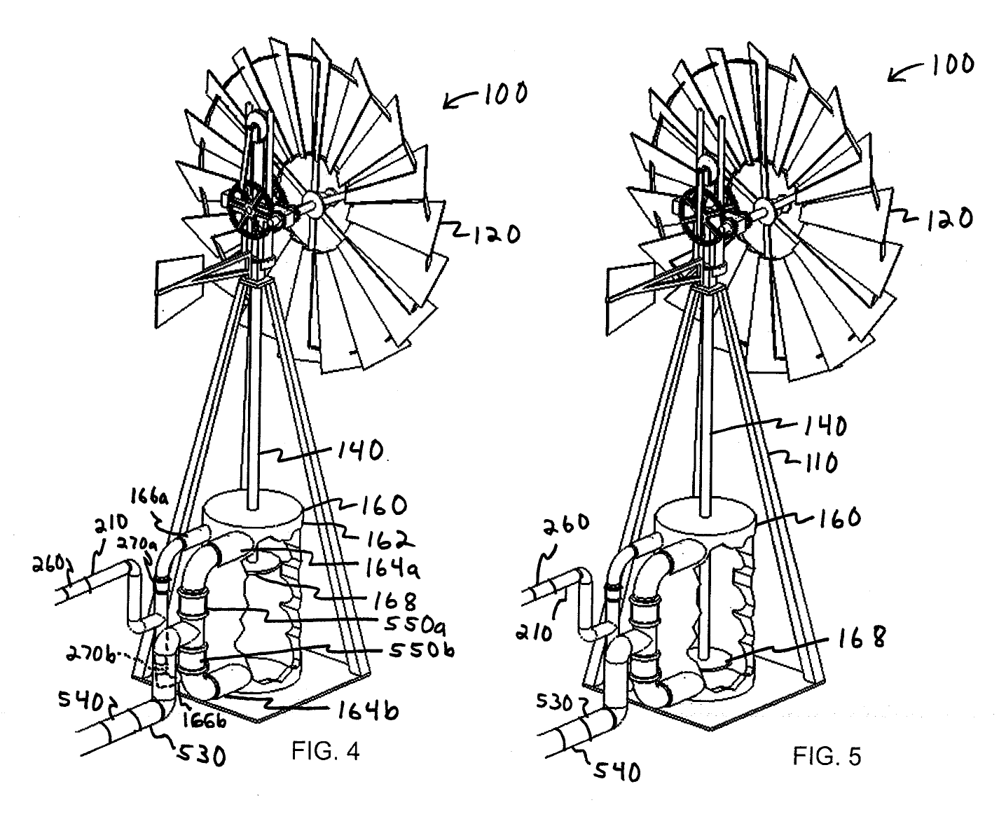

FIGS. 1-5 show an example system 10 for converting dynamic fluid energy. In particular, the system 10 can convert gaseous fluid energy into electrical power.

The system 10 shown includes a plurality of pumping mechanisms 100, a conduit system 200, an electrical power generator mechanism 400, and a conduit system 500. Although the system 10 is shown with four pumping mechanisms 100, the system 10 may include one or more pumping mechanisms 100. A plurality of pumping mechanisms 100 may produce an increased and/or more continuous flow of pumping fluid. The pumping fluid may be hydraulic fluid, oil, water, or any other appropriate fluid.

Each pumping mechanism 100 may include a flow-driven moveable member 120 coupled to a pump 160. The moveable member 120 may be supported by a support structure 110. The moveable member 120 may be rotated by a gaseous flow, such as wind, passing around elements 122 of the moveable member 120. In certain implementations, the elements may, for example, be vanes or air foils.

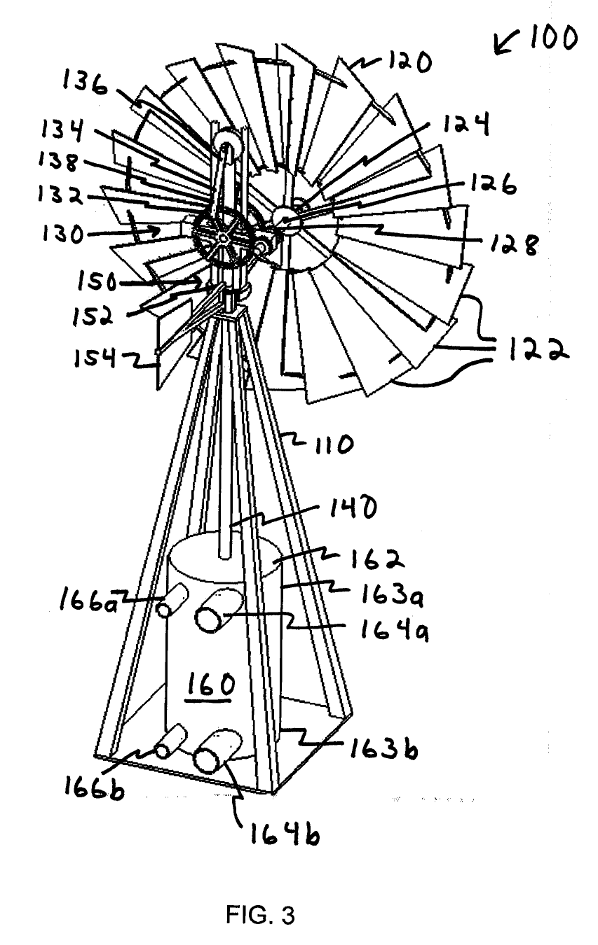

Referring to FIGS. 3-5, the elements 122 of the moveable member 120 are coupled to a hub 124. The hub 124 is coupled to a shaft 126 that rotates as the moveable member 120 rotates. The shaft 126 is also coupled to the pump 160 through a power conversion system 130. As illustrated, the conversion system 130 operates the pump 160 at a desired rate in relation to the moveable member 120. The conversion system 130 may convert the motion of the moveable member 120 (e.g., rotary) into an appropriate motion for the pump 160 (e.g., linear). The conversion system 130 may, for example, include a gear box or reducer.

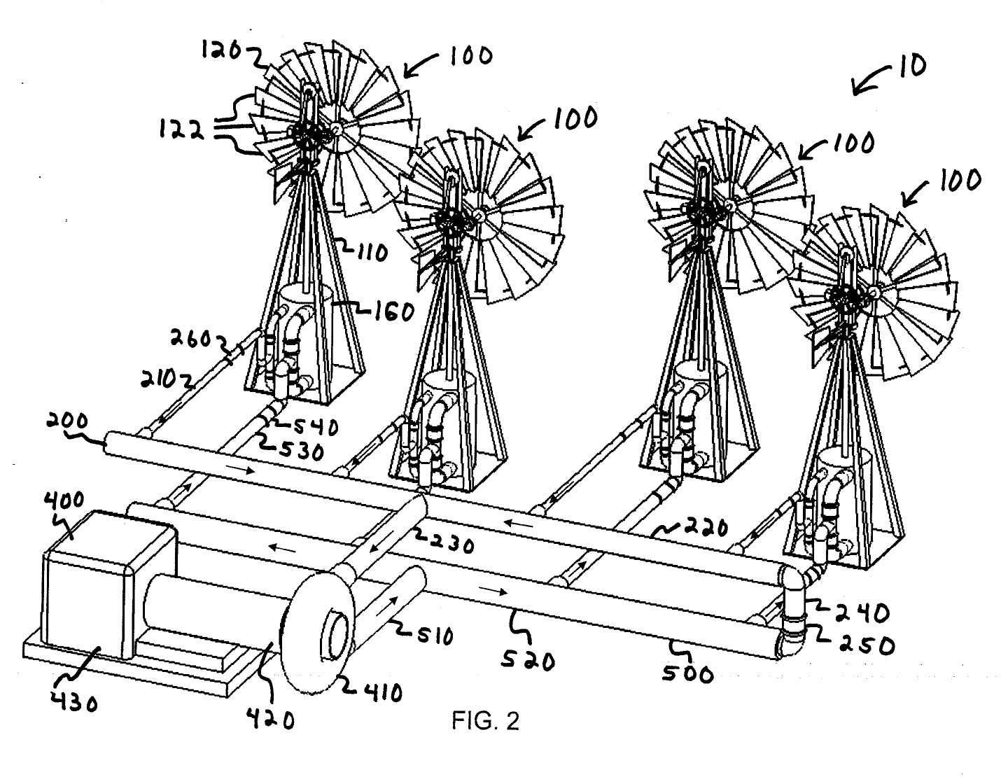

As shown in the example implementation of FIG. 3, for example, first gears 128 attached to the shaft 126 mate with second gears 132 of the conversion system 130. As the second gears 132 are driven by the first gears 128, the second gears 132 actuate connecting rods 134. The connecting rods 134 are also coupled to a plunger 140, and drive the plunger 140 in response to the second gears 132. Although FIGS. 2-5 show two first and second gears 128, 132, there may be any number of first and second gears 128, 132. Additionally, any number of connecting rods 134 could be used. For example, a single connecting rod 134 may be used if only a single second gear 132 were used. The implementations shown in the figures are used only as an example and are not intended to be limiting.

The connecting rods 134 may be pivotably connected to the plunger 140 at or near a first end 136 of the connecting rods 134. The connecting rods 134 may also be pivotably connected to a radius of the second gears 132 at or near a second end 138 of the connecting rods 134. Adjusting the size of the first gears 128 and the second gears 132 and/or adjusting the radius at which the connecting rods 134 are connected to the second gears 132 affects the operational rate of the plunger 140. For example, for a given rotational speed of the moveable member 120, increasing the radius of the second gear 132 relative to the first gear 128 decreases the rotational speed of the second gear 132. Alternatively, decreasing the radius of the second gear 132 relative to the first gear 128 increases the rotational speed of the second gear 132. On the other hand, increasing the radius of the first gear 128 relative to the second gear 132 increases the rotational speed of the second gear 132. Similarly, decreasing the radius of the first gear 128 relative to the second gear 132 decreases the rotational speed of the second gear 132. The movement of the plunger 140 will change in accordance with the rotational speed of the second gear 132, as explained above.

The moveable member 120 may also include an alignment system 150 that may be used to align the moveable member 120 in a desired orientation. For example, the alignment system 150 may include a pivot 152 that allows the turbine to rotate about a vertical axis. The rotation may, for example, be used to align the moveable member 120 with a predominant fluid flow direction. The moveable member 120 may be moved about the pivot by an alignment device 154, which may be activated by the wind.

The moveable member 120 may also include one or more brakes for slowing and/or stopping a motion of the moveable member 120. For example, a first brake may be used for stopping and/or slowing a rotational speed of the moveable member 120. A second brake may be used to fix the moveable member 120 into a desired configuration. According to some implementations, the brakes may be separate devices or a single device and may be used to adjust the operation of the moveable member 120, such as during adverse weather conditions, although the brakes may be used under any conditions.

Referring again to FIGS. 3-5, the pump 160 includes an outer casing 162 and a piston 168 disposed in the outer casing 162 and coupled to the plunger 140. The example pump 160 has dual-action functionality. As such, the pump 160 simultaneously intakes and expels a portion of the pumping fluid during both an upward and downward motion of the piston 168. In other implementations, the pump 160 may have a single-action functionality. That is, the pump 160 may intake pumping fluid during one of an upwards or downwards motion of the piston 168 and may output pumping fluid during the other of the upwards or downwards motion. Accordingly, such an implementation may only require a single inlet conduit and a single outlet conduit. Such inlet and outlet conduits may be attached to a first portion 163a and/or a second portion 163b of the outer casing 162 of the pump 160.

In this illustrated implementation, a first inlet conduit 164a for conducting the pumping fluid into the outer casing 162 of the pump 160 is attached to the first portion 163a, and a second inlet conduit 164b for conducting the pumping fluid into the outer casing 162 is attached to the second portion 163b. A first outlet conduit 166a for conducting the pumping fluid out of the outer casing 162 is attached to the first portion 163a, and a second outlet conduit 166b for conducting the pumping fluid out of the outer casing 162 is attached to the second portion 163b. The first and second inlet conduits 164a, 164b and the first and second outlet conduits 166a, 166b provide for fluid communication with an interior of the outer casing 162 of the pump 160. Thus, the pumping fluid is able to flow through the conduits 164-166 and into or out of the interior of the outer casing 162. The flow is controlled by a set of valves, which are described below.

Coupled to the first and second inlet conduits 164a, 164b is the return conduit 530. The return conduit 530 couples to both the first and second inlet conduits 164a, 164b so that pumping fluid may be drawn through both of the inlet conduits from the return conduit. The return conduit 530 includes two valves 550a, 550b disposed upstream from the inlet conduits to control the flow through the inlet conduits. In particular implementations, the valves 550a, 550b may only permit fluid to flow in the direction of the pump 160. The valves 550, 550b may, for example, be check valves.

Coupled to the first and second outlet conduits 166a, 166b is the outlet conduit 210. The outlet conduit 210 couples to both the first and second outlet conduits 166a, 166b so that pumping fluid may be conveyed through both of the inlet conduits to the outlet conduit 210. The outlet conduit 210 includes two valves 270a, 270b disposed downstream from the outlet conduits. In particular implementations, the valves 270a, 270b may only permit fluid to flow away from the pump 160. The valves 270a, 270b may, for example, be check valves.

In one mode of operation, as the piston 168 is moved toward the moveable member 120, the valve 270a allows fluid to exit the pump 160 and enter the outlet conduit 210. At the same time, the valve 270b prevents the exiting fluid from re-entering the pump 160. Additionally, the valve 550b allows fluid to flow into the pump 160 from the return conduit 530. The valve 550a prevents the exiting fluid from entering the return conduit 530. As the piston is moved away from the moveable member 120, however, the valve 270b allows fluid to exit the pump 160 and enter the outlet conduit 210, and the valve 270a prevents the exiting fluid from re-entering the pump 160. Additionally, the valve 550a allows fluid to flow into the pump 160 from the return conduit 530, and the valve 550b prevents the exiting fluid from entering the return conduit 530.

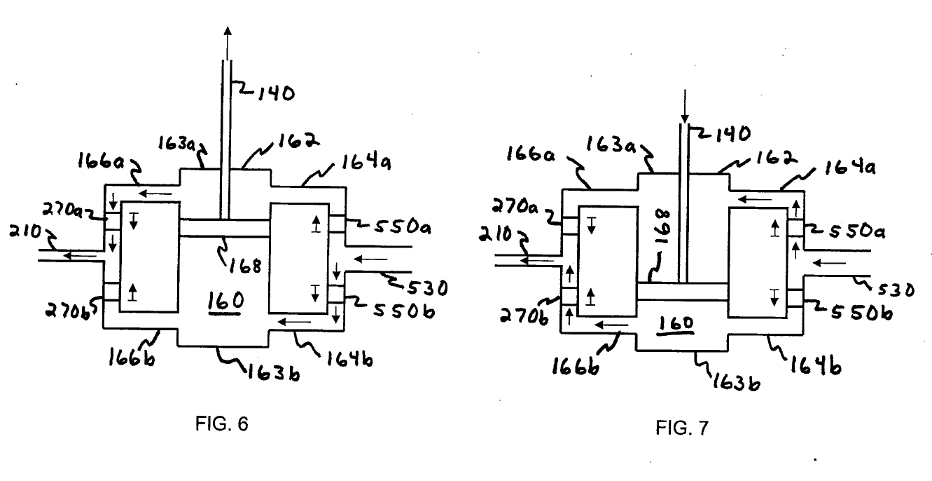

The operation of the pump 160 is described best with reference to FIGS. 6-7. In operation, the plunger 140 reciprocates the piston 168 between a position near the first portion 163a and the second portion 163b of the outer casing 162. As the piston 168 moves towards the first portion 163a (see FIG. 6), the pressure below the piston 168 is reduced. This lower pressure causes the valve 550b to open, drawing the pumping fluid from the return conduit 530 and into the outer casing 162, through the inlet conduit 164b and the valve 550b. At the same time, the pressure above the piston 168 increases, forcing the pumping fluid out through the outlet conduit 166a and the valve 270a and into the outlet conduit 210. The pumping fluid is prevented from being forced out of the inlet conduit 164a by the valve 550a and into the outlet conduit 166b by the valve 270b.

As the plunger 140 moves the piston 168 moves towards the second portion 163b (see FIG. 7), the pressure above the piston 168 decreases, causing the valve 550a to open, drawing the pumping fluid from the return conduit 530 and into the outer casing 162, through the valve 550a and the inlet conduit 164a. At the same time, the pumping fluid below the piston 168 is forced out through the outlet conduit 166b and the valve 270b and into the outlet conduit 210. The valve 550b prevents the pumping fluid from flowing out of the outer casing 162 through the inlet conduit 164b, and the valve 270a prevents pumping fluid from flowing through the outlet conduit 166a and into the outer casing 162.

As just discussed, pumping fluid may be simultaneously be drawn into and pumped out of the pump 160 during both the upward and downward stroke of the piston 168. Thus, at least in some implementations, the pumping of the fluid may be double action.

Referring to FIG. 2, the pumping mechanisms 100 are coupled to the power generator mechanism 400 through the conduit system 200 and the conduit system 500. The conduit system 200 may include the outlet conduits 210, a supply manifold 220, and a supply conduit 230. Similarly, the conduit system 500 may include a return conduit 510, a return manifold 520, and return conduits 530. As shown, the outlet conduits 210 join to the supply manifold 220, and the supply manifold joins to the supply conduit 230. The supply conduit 230 extends between the supply manifold 220 and the power generator mechanism 400. The return conduit 510 extends between the generator mechanism 400 and the return manifold 520, which joins the return conduits 530.

A bypass conduit 240 may extend between the supply manifold 220 and the return manifold 520 and may include a valve 250 disposed therein. The valve 250 may be, for example, a pressure relief valve. Consequently, if a pressure in the supply manifold 220 exceeds a selected pressure, the valve 250 may open, causing all or a portion of the pumping fluid to be conveyed into the return manifold 520.

Each return conduit 530 may include a valve 540, and each outlet conduit 210 may include a valve 260. Valves 540, 260 may be sensor-actuated valves and may be actuated in response to a signal from a sensor provided at one or more locations of the system 10. For example, a sensor may be located in the pumps 160, the conduit system 200, the power generator mechanism 400, or other locations. The sensors may, for example, activate the valves if contaminants are detected in the pumping fluid. Valves 540, 260 may also be user-actuated valves. A user may, for example, close a set of valves when repairing or replacing components of a pumping mechanism 100.

In certain implementations, a valve may allow the pumping fluid to be recirculated to a pump 160. For example, a valve may be coupled between the inlet conduits 164 and the outlet conduits 166 or between a supply conduit 210 and a return conduit 530. If a detrimental condition is detected (e.g., contamination), the valve may be opened to allow the pressurized pumping fluid to recirculate to the pump 160. Thus, the pumping mechanism 100 may continue to operate without the contaminated fluid reaching the rest of the system 10.

The power generator mechanism 400 includes a mechanical-power converter 410, which is coupled to supply conduit 230 and return conduit 510. The power generator mechanism also includes a power transmission mechanism 420 that couples the mechanical-power converter 410 to an electrical generator 430. The mechanical-power converter 410 may receive the fluid flow from supply conduit 230 and convert it into a mechanical driving force. For instance, the mechanical-power converter 410 can convert the power of the fluid flow into rotary power, and the rotary power can drive the electrical generator 430. In particular implementations, for example, the mechanical-power converter 410 can be a turbine, and the power transmission mechanism 420 can be a shaft.

In one mode of operation, wind causes the moving members 120 to rotate, thereby rotating the shafts 126 associated with the moving members 120. As mentioned above, the moving members 120 may be aligned in a desired direction with the alignment device 154, for example, to convert the wind energy efficiently. As the shafts 126 rotate, the plungers 140 are cyclically actuated through the conversion systems 130. The plungers 140 actuate the pumps 160, which draw the pumping fluid traveling through the return conduit 510, the return manifold 520, and the return conduits 530 into the pumps 160 via the inlet conduits 164a, 164b. The pressurized pumping fluid is pressurized within the pumps 160 and output from the outlet conduits 166a, 166b. The pumping fluid is conveyed to the generator mechanism 400 via outlet conduits 210, the supply manifold 220, and the supply conduit 230. The pressurized pumping fluid is used to actuate (e.g., spin) the mechanical-power converter 410. The mechanical-power converter 410 actuates the power transmission mechanism 420, which is coupled to the electrical generator 430. The electrical generator 430 converts the mechanical power of the power transmission mechanism 420 into electrical energy.

After the pumping fluid has been utilized to generate electrical power at the generator mechanism 400, the pumping fluid may be returned to the pumping mechanisms 100 through the conduit system 500. The pumping fluid in return conduit 510 may be returned to the pumping mechanisms 100 through positive pressure, negative pressure, and/or gravity. The return of the pumping fluid to the pumping mechanisms 100 through the conduit system 500 may provide a cooling process for the pumping fluid, which may in turn cool the components of pumping mechanisms 100. In some implementations, the cooling may be accomplished by heat exchange with the air around the conduit system 500.

The system 10 has a variety of features. For example, as opposed to generating electrical power through burning fossil fuels (e.g., coal), electrical power may be generated through using a renewable energy source with little, if any, air pollution. Thus, the energy source may be used almost indefinitely and have a small effect on environmental quality. As another example, the energy source may be found at a variety of locations in a variety of countries. Thus, the power generation may be scaled as needed and may have widespread use.

Other implementations of power generation system 10 may have additional features. For example, conditions that may indicate and/or cause adverse environmental conditions may be monitored and, if detected, contained. For instance, appropriate sensors could detect contamination/leakage of the pumping fluid and use isolation mechanisms (e.g., valves) to stop the flow of pumping fluid to and/or from a fluid pumping mechanism 100 and/or a mechanical-power converter 410. As another example, the pumping fluid could be biodegradable. Thus, the power generation system 10 may provide a minimal impact on the environment if a problem does arise.

Although four pumping mechanisms 100 are illustrated, other implementations may include fewer or additional pumping mechanisms 100. Additionally, the pumping mechanisms 100 may be joined with one or more generator mechanisms 400 via power transmission mechanisms 420 and corresponding mechanical-power converters 410. Moreover, in certain implementations, two or more pumping mechanisms 100 may be used in a many-to-one correspondence with a mechanical-power converter 410, as explained above. In particular implementations, for instance, a power transmission mechanism 420 may be driven by only one mechanical power converter 410, which may be driven by one or more pumping mechanisms 100.

According to certain implementations, the power generator mechanism 400 may include a plurality of mechanical-power converters 410, each corresponding to one or a group of pumping mechanisms 100. The pumping fluid from each pumping mechanism 100 or group of pumping mechanisms 100 may be directed to a corresponding mechanical-power converter 410 through a corresponding conduit system. The mechanical-power converters 410 may be actuatable by the pressurized pumping fluid and coupled to one or more power transmission mechanisms 420. Therefore, as the pressurized pumping fluid actuates a mechanical-power converter 410, a power transmission mechanism 420 is also actuated. The actuation of a power transmission mechanism 420 consequently drives an electrical generator 430 to generate electrical power.

As shown, the outlet conduit 210 has a smaller diameter than the return conduit 530 because the pumping fluid passing through the outlet conduit 210 may have a higher pressure than the pumping fluid passing through the return conduit 530. However, the conduits 530, 210 may be any size. For example, the outlet conduit 210 may be larger than the return conduit 530 or vice versa. The conduits 530, 210 may also be the same size in certain implementations.

The movable members 120, the pumps 160, the inlet conduits 164, the outlet conduits 166, the return conduits 530, the outlet conduits 210, the supply conduit 230, the return conduit 510, the supply manifold 220, the return manifold 520, the mechanical-power converter 410, the power transmission mechanism 420, and the electrical generator 430, as well as other components of the system 10, may be sized according to an intended application, taking into consideration factors such as an amount of power to be generated, the anticipated flow speed, etc. Certain implementations may include a housing having an inner chamber. The inner chamber may act as a fluid reservoir from which the pumping fluid may be drawn into the pump. In particular implementations, the pump 160 may also be located in the housing, or even in the inner chamber.

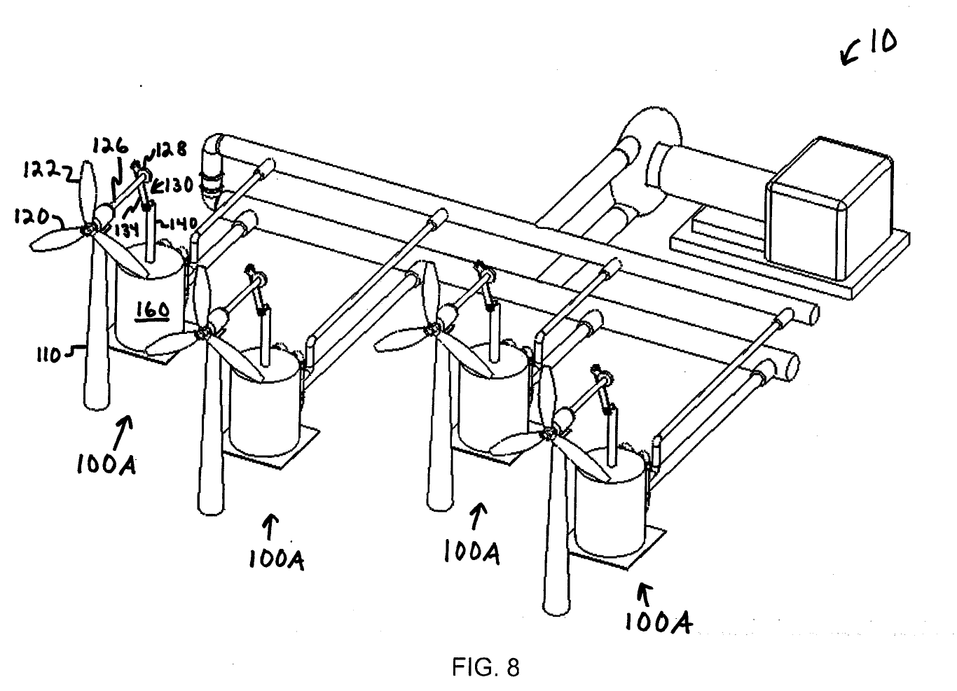

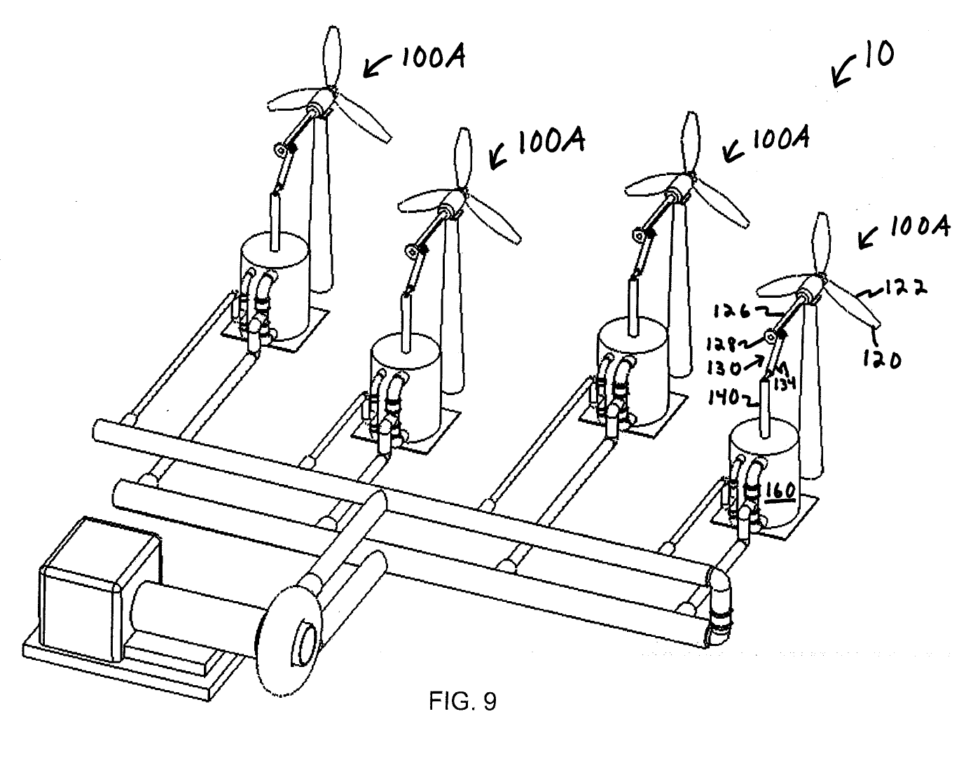

FIGS. 8-9 illustrate another example implementation of a system 10 for converting dynamic fluid energy. In particular, the system 10 includes pumping mechanisms 100A that can be used for electrical power generation. Each pumping mechanism 100A includes a moveable member 120, a conversion system 130, and a pump 160. The moveable member 120 includes a number of elements 122 and a shaft 126 having a radially enlarged portion 128 at or near an end thereof. The conversion system 130 includes a connecting rod 134 having a first end that is pivotably coupled to the radially enlarged portion 128 and a second end that is pivotably coupled to a plunger 140. In this implementation, the shaft 126 and the conversion system 130 are arranged to allow the pump 160 to be located out from under a support structure 110 for the pumping mechanism 100A.

When it is driven by a gaseous fluid, moveable member 120 drives shaft 126 rotationally. As the shaft 126 rotates, the first end of the connecting rod 134 traces an arc having a defined radius around the longitudinal axis of the shaft 126. Consequently, the plunger 140 cyclically rises and falls. This cyclical movement of the plunger 140 drives the pumping action of the pump 160. The pump 160 may, for example, operate similarly to the pump in FIGS. 3-5.

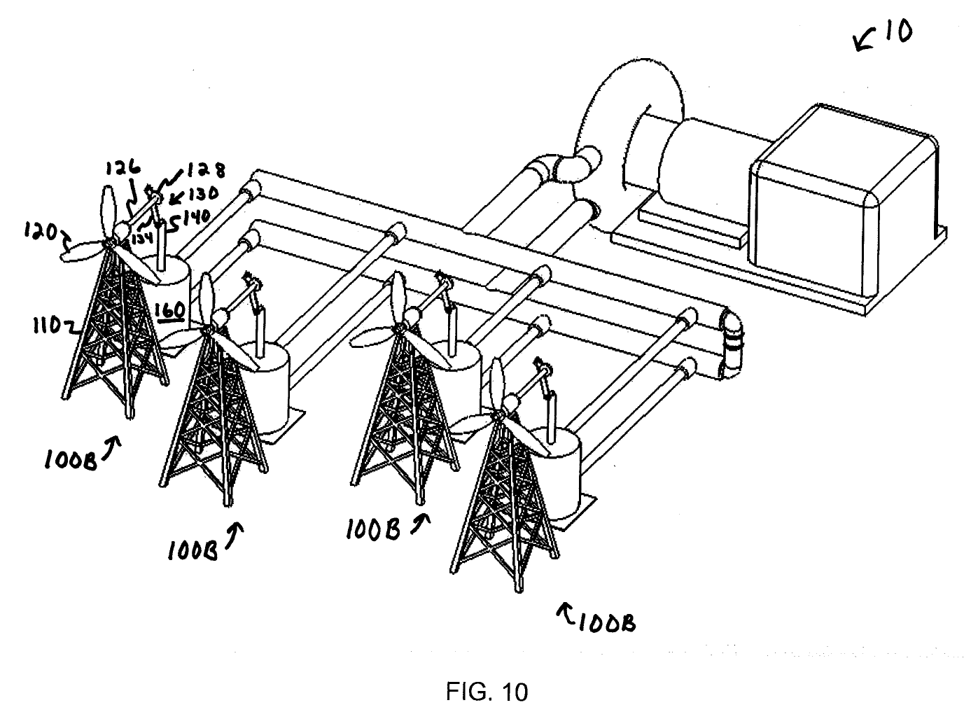

FIG. 10 illustrates another example implementation of a system 10 for converting dynamic fluid energy. The system 10 includes pumping mechanisms 100B, which can be used for generating electrical power. Each pumping mechanism 100B includes a moveable member 120, a conversion system 130, and a pump 160. The moveable member 120 includes a shaft 126 having a radially enlarged portion 128 at or near an end thereof. The conversion system 130 includes a connecting rod 134 having a first end that is pivotably coupled to the radially enlarged portion 128 and a second end that is pivotably coupled to a plunger 140. In this implementation, the shaft 126 and the conversion system 130 are arranged to allow the pump 160 to be located out from under a support structure 110 for the pumping mechanism 100B.

When it is driven by a gaseous fluid, moveable member 120 drives shaft 126 rotationally. As the shaft 126 rotates, the first end of the connecting rod 134 traces an arc having a defined radius around the longitudinal axis of the shaft 126. Consequently, the plunger 140 cyclically rises and falls. This cyclical movement of the plunger 140 drives the pumping action of the pump 160.

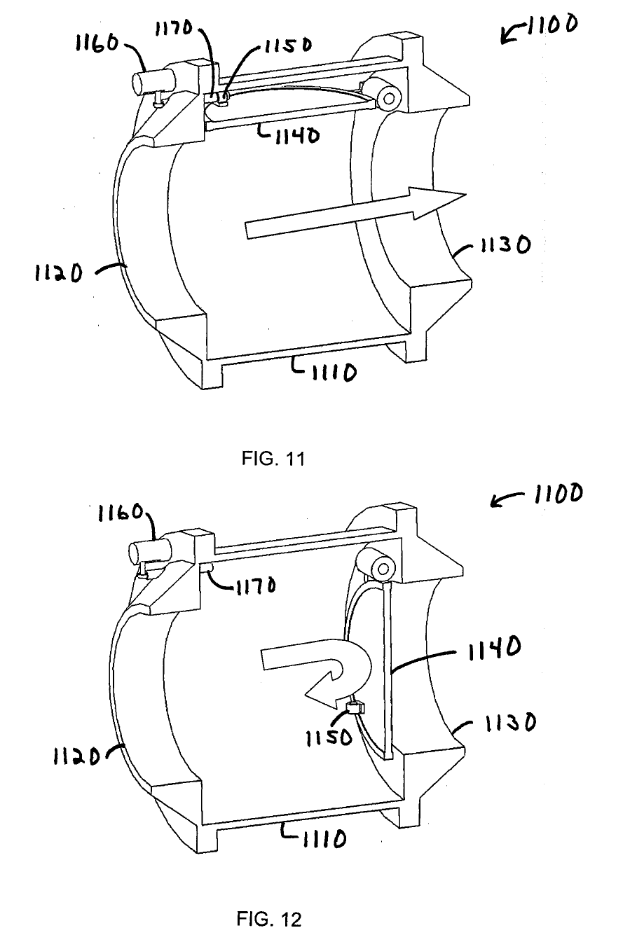

FIGS. 11-12 show an example valve 1100 that may be similar to the valves 260, 540. The valve 1100 includes a body 1110 having first and second openings 1120, 1130 and a gate 1140 pivotable within the body 1110. During normal operations, the gate 1140 may be fixed in an open position providing open communication between the first and second openings 1120, 1130. If a selected condition occurs, such as if contamination or a leak is detected, the gate 1140 may be released and pivot downwardly into a closed position, preventing fluid from passing through the valve 1100. According to the example valve shown in FIGS. 11 and 12, the gate 1140 includes an appendage 1150 extending therefrom. Thus, when a condition is detected, an actuator 1160 retracts a pin 1170 extending through an opening formed in the appendage 1150, and the gate 1140 pivots downwardly, sealing the valve 1100. The valve 1100 may also be user-actuated.

A system 10 may include additional and/or different valves. For example, the additional and/or other valves may be manually actuated, e.g., actuated via a hand-crank. The valves included in the system, including the valves 260, 540 may be operable to stop flow of the pumping fluid through the return conduits 210 and the outlet conduits 530 when a selected condition is detected, actuated in order to isolate the associated pump 160, or for some other reason. For example, a pump 160 may be removable for maintenance, repair, and/or replacement. Accordingly, the output conduit 210 and return conduit 530 may include one or more shut-off valves. The shut-off valves may be similar to the sensor actuated valves 260, 540. The shut-off valves may be disposed on opposite sides of a disconnect, which may be a pair of flanged ends abutting one another or any other mechanism for detaching one end of a conduit from another end. When disconnecting the pump 160 from the output conduit 210 and the return conduit 530, the shut-off valves may be closed and the disconnect uncoupled. Consequently, pumping fluid is prevented from entering the pump 160 or the inlet conduits 164 from the return conduit 530 or leaving the pump 160 or the outlet conduits 166 for the supply conduit 210.

As mentioned above, the system 10 may include one or more sensors for detecting an operating condition of the system 10. Operating conditions may include a flow rate within the system 10, a quality of the pumping fluid (e.g., the amount of a contaminant in the pumping fluid), a pumping speed of the pump 160, a rotational speed of the moveable member 120, an output of the power generator mechanism 400, or some other aspect of the system 10 desired to be measured. Contaminants may include dirt, water, or chemical impurities, for example. The sensor may be communicably coupled to the valve 260 and/or the valve 540, or some other valve(s) within the system 10. If a predetermined operating condition is detected, the sensor may send a signal to one or more valves, such as valves 260, 540, adjusting a position thereof. For example, the sensor may command the valves 260, 540 to close or otherwise redirect a flow of the pumping fluid. Consequently, when contamination is detected, the pumped fluid may be prevented from being conveyed from and/or to the power generator mechanism 400.

Power to a sensor, one or more sensor actuated valves of the system, or other devices may be provided, for example, by a power line, battery, or any other power source, such as solar power. Further, a sensor may be adapted to provide an alarm signal when the predetermined condition is detected. For example, a sensor may send the alarm signal to one or more lights disposed on the pumping mechanisms 100. Further, the alarm signal may be transmitted via a wired or wireless connection to a remote user to indicate the occurrence of the predetermined condition.

As indicated above, each pumping mechanism 100 may have one or more associated flow rate sensors. A flow rate sensor may be provided on one or more of the return conduits 530 and the outlet conduits 210, the supply manifold 220, the return manifold 520, the supply conduit 230, and the return conduit 510. The flow rate sensor may measure a flow rate of the pumping fluid passing through a conduit of the system 10. According to some implementations, the flow rate sensors may transmit a signal indicating the measured flow rate of the pumping fluid to a controller. The flow rate measurements may be compared, and an alarm may be triggered if a difference between the flow rate measurements exceeds a selected amount. For example, the flow rate sensors may transmit the flow rate measurements to a central controller that may compare the measurement values and determine if a difference, if any, exceeds a predetermined amount. Such a difference may, for example, indicate a leak. Further, the controller may open or close one or more of the valves of the system 10. For example, the controller may open or close one or more of the valves 260, 540 in order to adjust an amount of the pumping fluid conveyed to or from the pumping mechanisms 100 or stop flow of the pumping fluid to or from the pumping mechanisms 100 or both. The central controller may be a human user or may be a mechanical or electronic device operable to receive, analyze, and transmit signals.

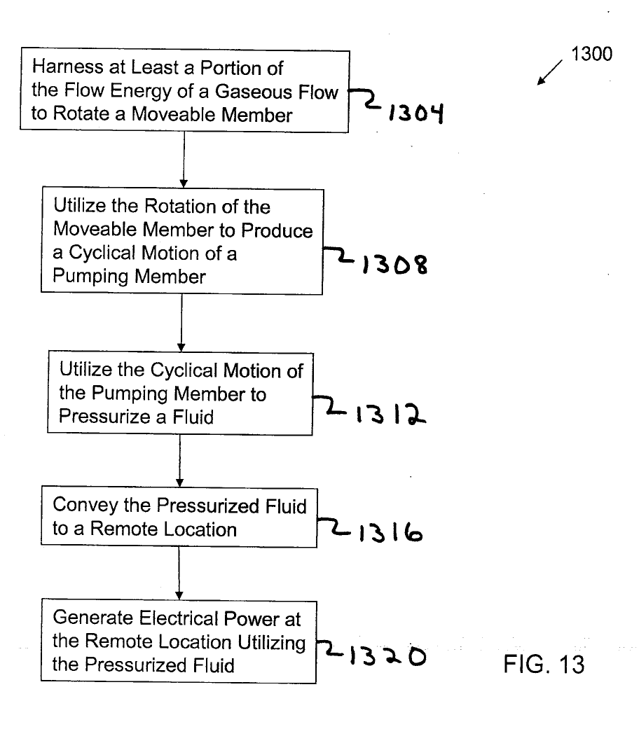

FIG. 13 illustrates an example process 1300 for converting dynamic fluid energy. Process 1300 calls for harnessing at least a portion of the flow energy of a gaseous flow to rotate a moveable member (operation 1304). For example, the energy of a wind current may be harnessed by disposing a wind turbine within the wind flow to rotate a portion of the turbine. The rotational motion of the moveable member is used to produce a cyclical motion, such as a back-and-forth linear motion, of a pumping member (e.g., an elongated member) (operation 1308). The pumping member may, for example, be a plunger coupled to a rotating portion of the moveable member. The cyclical motion of the pumping member is used to pressurize a fluid (operation 1312). For example, a pumping member may have a piston disposed at one end thereof, and the piston may be made to reciprocate within a pump to pressurize a fluid. The pressurized fluid is conducted to a remote location (operation 1316). For example, the pressurized fluid may form a fluid flow that is conveyed through a system of conduits to the remote location. At the remote location, the pressurized fluid is used to generate electrical power (operation 1320). For example, the pressurized fluid may be made to actuate a turbine that is coupled to an electrical power generator such that the generator generates electricity when actuated by the turbine.

Although FIG. 13 illustrates one process for converting dynamic fluid energy, other processes for converting dynamic fluid energy may include fewer, additional, and/or a different arrangement of operations. For example, a process may include conveying the fluid, possibly in a depressurized state, back to the pumping member. As another example, a number of moveable members may be exposed to the flow to actuate a number of pumping members. The pressurized fluid from the pumping members may be used individually or in combination to generate electricity. Additionally, two or more of a process's operations may be performed in a contemporaneous or simultaneous manner. In particular modes of operation, for example, all of a processes operations may be occur at the same time. Moreover, a processes operations may be performed continuously or intermittently for any period of time.

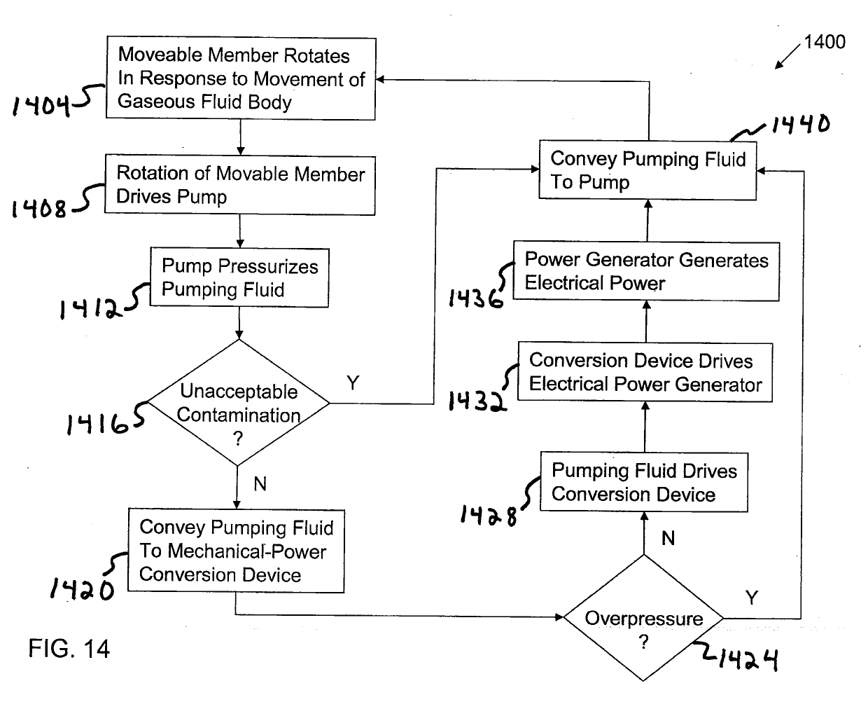

FIG. 14 illustrates another example process 1400 for converting dynamic fluid energy. Process 1400 calls for a moveable member rotating in response to movement of a gaseous fluid body (operation 1404). For example, a wind current may rotate a wind turbine within a wind flow. The rotation of the moveable member drives a pump (operation 1408). The pump may, for example, include a double-action piston pump. The moveable member and the pump may be coupled together through a power transmission mechanism, which may produce a cyclical motion for the pumping mechanism. The pump pressurizes a pumping fluid in response to being driven (operation 1412). For example, a piston may be made to move within a housing to pressurize a fluid.

The pumping fluid may be analyzed to determine whether it is unacceptably contaminated (operation 1416). A sensor may, for example, determine whether too much particulate matter is present in the pumping fluid, which may degrade mechanical components. If the level of contamination is not unacceptable, the pumping fluid is conveyed to a mechanical-power conversion device (operation 1420). The pressurized pumping fluid may, for example, form a flow that is conveyed by a conduit system.

While being conveyed to the conversion device, a determination is made regarding whether the pressure of the pumping fluid is too high (operation 1424). A sensor may, for example, determine whether the pressure of the pumping fluid is to high. If the pressure of the pumping fluid is not too high, the pumping fluid arrives at the conversion device and drives it (operation 1428). The conversion device may, for example, be a turbine, and the pumping fluid may flow around the turbine's vanes to drive the turbine.

The conversion device drives an electrical power generator (operation 1432). The conversion device may, for example, be coupled to the power generator through the use of a rotary shaft. The power generator generates electrical power in response to being driven by the conversion device (operation 1436).

The pumping fluid is conveyed back to the pump from the conversion device (operation 1440). The pumping fluid may then again be pressurized by another movement of the fluid body.

If, however, an unacceptable level of contamination is detected in the pumping fluid (operation 1416), the pumping fluid may be conveyed back to the pump (operation 1440). Thus, contaminated pumping fluid may prevented from reaching the conduit system, the conversion device, and/or other components of the power generation system.

Additionally, if too much pressure is detected in the pumping fluid (operation 1424), the pumping fluid may be conveyed back to the pump (operation 1440). Thus, over-pressurized pumping fluid may be prevented from reaching the conversion device.

Although FIG. 14 illustrates one implementation of a process for converting dynamic fluid energy, other implementations may include fewer, additional, and/or a different arrangement of operations. For example, a process for converting dynamic fluid energy may include a number of moveable members that are exposed to the flow to actuate a number of pumps. The pressurized fluid from the pumps may be used individually or in combination to generate electricity. Additionally, two or more of a process's operations may be performed in a contemporaneous or simultaneous manner. In particular modes of operation, for example, all of a processes operations may occur at the same time. Moreover, a process's operations may be performed continuously or intermittently for any period of time. As another example, checking for contamination and/or overpressure may not be performed.

A number of implementations have been described, and several others have been mentioned or suggested. Additionally, various additions, deletions, substitutions, and/or modifications to these implementations will readily be suggested to those skilled in the art while still achieving dynamic fluid energy conversion. Thus, it will be understood that various implementations for achieving dynamic fluid energy conversion may be achieved without departing from the essence of the disclosure. Moreover, the scope of protectable subject matter should be judged based on the claims, which may encompass one or more aspects of one or more implementations.

What is claimed is:

1. A system for utilizing movements of a gaseous fluid body for generating electrical power, the system comprising:
a first pumping mechanism comprising:
a flow-driven moveable member including a number of radially extending elements, the moveable member adapted to rotate in response to movement of a gaseous fluid body around the elements, and
a pump coupled to the moveable member and adapted to pressurize a pumping fluid in response to motion of the moveable member; and
an electrical power generation mechanism adapted to utilize the pressurized pumping fluid to generate electrical power.

2. The system of claim 1, further comprising a housing, the housing comprising an inner chamber from which the pump draws the fluid to be pressurized.

3. The system of claim 2, wherein the chamber serves as a reservoir for the pumping fluid.

4. The system of claim 1, wherein the moveable member comprises:
a hub to which the radially extending elements are coupled; and
an alignment system adapted to align the member with fluid body movements.

5. The system of claim 1, wherein the pump comprises:
a container having a moveable piston housed therein;
at least one fluid inlet conduit coupled to the container;
a first one-way valve coupled to the at least one fluid inlet conduit;
at least one fluid outlet conduit coupled to the container; and
a second one-way valve coupled to the at least one fluid outlet conduit.

6. The system of claim 1, further comprising a power conversion mechanism adapted to convey power from the moveable member to the pump.

7. The system of claim 6, wherein the power conversion mechanism comprises a gear coupled to the movable member and an arm coupled to the pump, wherein the arm is driven by the gear.

8. The system of claim 1, further comprising a second pumping mechanism, the second pumping mechanism comprising:
a fluid-driven moveable member including a number of radially extending elements, the moveable member adapted to rotate in response to movement of a gaseous fluid body around the elements; and
a pump coupled to the moveable member and adapted to pressurize a pumping fluid in response to motion of the moveable member.

9. The system of claim 8, further comprising a conduit system for combining the pressurized pumping fluid from the first pumping mechanism and the second pumping mechanism and conveying the combined fluid to the power generation mechanism.

10. The system of claim 9, wherein the second pumping mechanism may cease supplying pressurized pumping fluid while the first pumping mechanism continues supplying pressurized pumping fluid.

11. The system of claim 10, wherein the second pumping mechanism may be replaced while the first pumping mechanism continues supplying pressurized pumping fluid.

12. The system of claim 9, further comprising a second conduit system for dispersing the fluid from the power generation mechanism to the pumping mechanisms.

13. The system of claim 12, further comprising:
a bypass conduit in communication with the first conduit system and the second conduit system; and
a bypass valve coupled to the bypass conduit, the bypass valve adapted to allow flow of the pressurized pumping fluid from the first conduit system to the second conduit system when a predetermined pressure of the pumping fluid is exceeded.

14. A system for utilizing movements of a gaseous fluid body for generating electrical power, the system comprising:
a plurality of pumping mechanisms, each pumping mechanism comprising:
a flow-driven moveable member including a number of radially extending elements, the moveable member adapted to rotate in response to movement of a gaseous fluid body around the elements, and
a pump coupled to the moveable member and adapted to pressurize a pumping fluid in response to motion of the moveable member; and
an electrical power generation mechanism operable to utilize the pressurized pumping fluid to generate electrical power.

15. The system of claim 14, further comprising a housing, the housing comprising an inner chamber from which the pump draws the fluid to be pressurized.

16. The system of claim 15, wherein the chamber serves as a reservoir for the pumping fluid.

17. The system claim 14, wherein the pumping mechanisms comprise a power transmission mechanism adapted to convey power from the moveable member to the pump.

18. The system of claim 14, further comprising a conduit system for combining the pressurized pumping fluid from the pumping mechanisms and conveying the combined fluid to the power generation mechanism.

19. The system of claim 18, wherein a pumping mechanism may cease supplying pressurized pumping fluid while the other pumping mechanisms continue supplying pressurized pumping fluid.

20. The system of claim 18, further comprising a second conduit system for dispersing the fluid from the power generation mechanism to the pumping mechanisms.

21. The system of claim 20, further comprising:
a bypass conduit in communication with the first conduit system and the second conduit system; and
a bypass valve coupled to the bypass conduit, the bypass valve adapted to allow flow of the pressurized pumping fluid between the first and second conduit systems when a predetermined pressure of the pumping fluid is exceeded.

22. A method for utilizing movements of a gaseous fluid body for generating electrical power, the method comprising:
driving a pump using the rotation of a flow-driven moveable member that rotates in response to movement of a gaseous fluid body;
pressurizing a pumping fluid with the pump;
conveying the pressurized pumping fluid to an electrical power generator mechanism; and
generating power with the electrical power generator mechanism using the pressurized pumping fluid.

23. The method of claim 22, further comprising providing the pumping fluid to a chamber from which the pump draws the fluid to be pressurized.

24. The method of claim 23, wherein the chamber serves as a reservoir for the pumping fluid.

25. The method of claim 22, further comprising aligning the movable member with fluid body movements.

26. The method of claim 22, further comprising:
driving a second pump using the rotation of a second flow-driven moveable member that rotates in response to movement of a gaseous fluid body;
pressurizing the pumping fluid with the second pump;
conveying the pressurized pumping fluid to the electrical power generator mechanism; and
generating power with the electrical power generator mechanism using the pressurized pumping fluid from the first pump and the second pump.

27. The method of claim 26, further comprising combining the pressurized pumping fluid from the first pump and the second pump before it arrives at the electrical power generator mechanism.

28. The method of claim 26, further conveying the pumping fluid from the electrical power generator mechanism to the pumps.

29. The method of claim 26, further comprising ceasing to supply pressurized pumping fluid to the electrical power generator mechanism from the second pump while continuing to supply pressurized pumping fluid from the first pump.
